(19) United States
(12) Patent Application Publication
(10) Pub. No.: US 2018/0103044 A1
(43) Pub. Date: Apr. 12, 2018

(54) ANTI-MALWARE CLIENT

(71) Applicant: Richard E. Malinowski, Colts Neck, NJ (US)

(72) Inventor: Richard E. Malinowski, Colts Neck, NJ (US)

(21) Appl. No.: 15/728,355

(22) Filed: Oct. 9, 2017

Related U.S. Application Data
(60) Provisional application No. 62/406,111, filed on Oct. 10, 2016.

(51) Int. Cl. H04L 29/06; G06F 21/53; G06N 3/02

(52) U.S. Cl. CPC H04L 63/145; G06N 3/02; H04L 63/1416; G06F 21/53

(57) ABSTRACT

Protecting devices and systems from electronic attacks is of paramount importance to the protection of such devices, systems, and their associated data. By executing search and/or destroy operations, a user device may be afforded protection without degrading the utility of the device. Device-implemented applications may (scan) search and destroy malware based upon inputs, such as a centralized and/or localized data protection server which may share signatures and/or countermeasures among other localized data protection servers and ultimately devices. As a result, an attack on one device can promptly be identified and remedies dispatched for execution quickly, such as to mitigate an ongoing or subsequent attack, and without degradation of the user experience.

### CROSS-REFERENCE TO RELATED APPLICATIONS

The present application claims the benefit of Patent Application No. 62/406,111, filed on Oct. 10, 2016, and which is incorporated herein by reference in its entirety.

### FIELD OF THE DISCLOSURE

The present disclosure is generally directed toward computer systems and devices and more particularly, to systems and methods for mitigating malware attacks thereon.

### BACKGROUND

Prior art anti-virus products on the market have a single flaw that renders their products unable to keep up with the reality of today's ever changing threat landscape. Namely, they continue to use people to discover, de-engineer, and manually create signatures for malware. This process is slow and inherently reactive, and by definition, can never get ahead of newly developed threats. Additionally, traditional anti-virus products are completely unable to deal with zero day attacks. It takes, on average, from six to twelve months for a traditional security vendor to discover, reverse engineer, test, and release signatures on a new threat. Even when signatures are in place, they can often be easily defeated by simply creating a slightly different version of the malware called a variant. Accordingly, most systems are vulnerable to infection or breach until the entire process is executed to completion for each signature or subsequent variant.

### SUMMARY

It is with respect to the above issues and other problems that the embodiments presented herein were contemplated.

REMTCS has developed an anti-malware client that leverages our enterprise security product, ProActive Security System (PASS), to reduce the client-side window of vulnerability down to as little as 24 hours or even less. This is achieved by performing the threat mitigation process entirely through the use of a Centralized Threat Information Database (CTID) coupled with a fully autonomous behavioral analysis instruction set (AI) instead of people.

The PASS enterprise product uses an engine we call Artificial Neural Network Intelligence (ANNI) to perform all of the functions normally executed by a large information security and forensics team, only in real-time. PASS monitors network and computer activity through behavioral analysis, reverse engineers suspected malware on the fly to determine intent and behavior, automatically deploys countermeasures to stop any found threat from continuing to act in a manner harmful to the organization, and then notifies the appropriate personnel of the actions taken. All of this happens in near real time; and with little to no human interaction. The malware forensic data is compiled into a database of threats and countermeasures, which is then shared on a frequent basis to subscribers to REMTCS' PASS Anti Malware Client.

For the end users of the PASS Anti Malware Client, this means that shortly after a first enterprise PASS customer has been hit with a new threat, other clients will be protected from the very same malware—even zero day threats.

In one embodiment, a method is disclosed, comprising: receiving, by a first server connected to a network, first data addressed to a device; determining, that the first data comprises a viral signature; and causing an agent to execute on the device to perform at least one of finding or destroying second data comprising the viral signature, wherein the agent executes during interrupts (during a time of low CPU usage) of a processor of the device.

In another embodiment, agent may utilize an interrupt of a portion of a processor (e.g., one core from a multi-core processor) or an interrupt of at least one processor while other processors may still be actively utilized by other processes. In yet another embodiment, the agent may utilize other computing and/or networking resources during their respective interrupts (e.g., during low or idle utilization). For example, an agent may need to perform a communication activity and, when the system is idle or otherwise executing tasks requiring low communication activity, the agent may then perform the communication activity.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “fully autonomous and automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage that participates in providing instructions to a processor for execution. Such a medium may take many forms, including, but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, an EPROM, a FLASH-EPROM, a solid-state medium like a memory card, any other memory chip or cartridge, or any other medium from which a computer can read, such as a USB thumb drive. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

While machine-executable instructions may be stored and executed locally to a particular machine (e.g., personal computer, mobile computing device, laptop, smartphone, tablet, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

The terms “determine,” “calculate,” and “compute,” and variations thereof, as used herein, are used interchangeably and include any type of methodology, process, mathematical operation, or technique.

The term “module,” as used herein, refers to any known or later-developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a timeline of exposure to malware in accordance with embodiments of the present disclosure;

FIG. 2 depicts a first system in accordance with embodiments of the present disclosure;

FIG. 3 depicts a first process in accordance with embodiments of the present disclosure;

FIG. 4 depicts a second process in accordance with embodiments of the present disclosure;

FIG. 5 depicts a second system in accordance with embodiments of the present disclosure; and

FIG. 6 depicts a third system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a sub-element identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices that may be shown in block diagram form and are well known or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

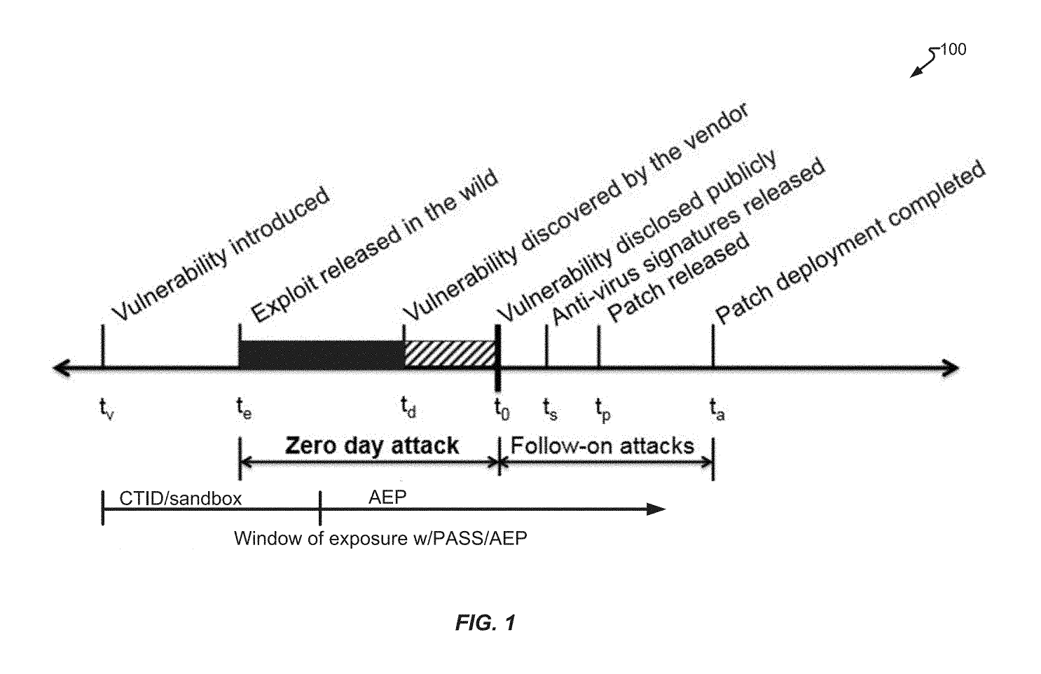

FIG. 1 depicts timeline of exposure 100 to malware in accordance with embodiments of the present disclosure. A common series events is illustrated in timeline of exposure 100 wherein: at time tᵥ a vulnerability is introduced, such as a newly created malware or new malware variant. Next, at time tₑ the exploit is released and may be received by a user device, such as from malware downloaded from a file or malicious website. Time tₑ may be an unknown or zero-day attack. Next, at time t_{d}, the vulnerability is discovered and at time to the vulnerability is disclosed to the public. The time from tₑ to t₀ is commonly referred to as a “zero day attack,” wherein a previously unknown vulnerability is discovered and, in the prior art, may comprise 3-9 months before being publicly disclosed.

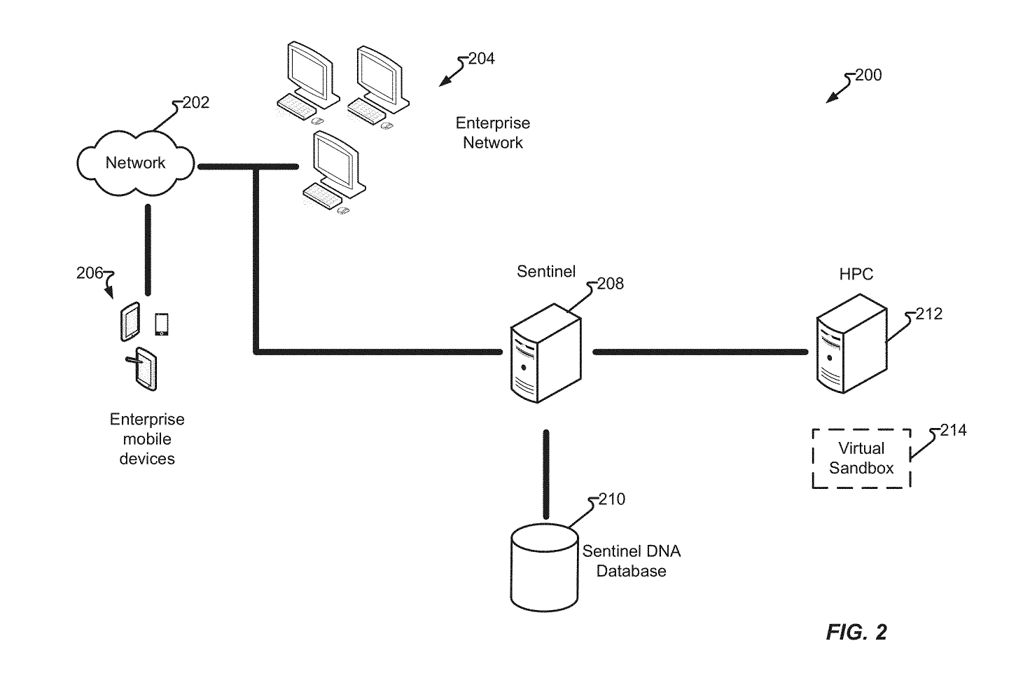

Next, at time tₛ, an anti-virus signature(s) is released, after deengineering by staff. The malware may now be detected and identified. At time tₚ, a patch is released. The patch may perform removal, inoculation, disablement and/or containment. At time tₐ, the patch has been completely deployed and the threat is no longer active. The time from tₑ to tₐ may be referred to as “follow-on attacks.” The prior art, which relies heavily on human agents, allows for a more significant window of exposure defined by time tₑ to tₐ. However, by implementing the teachings provided herein, the window of exposure may be more limited, such as from the time tᵥ to t_{d}. The time from tᵥ to a time after time tₑ and before time t_{d} may comprise CTID database updates and/or sandbox (see FIG. 2, element 214) performing automated behavior analysis, deengineering of malware, and/or discovery of variants. Any reoccurrence of the same or similar (e.g., variant) malware attack is then thwarted. PASS sends malware signatures to the antivirus database (ANNI Endpoint Wrapper (“AEP”)). AEP scans either for individual malware signature or conducts full scan (at a destination IP address of a particular device and, subsequently or concurrently, a full scan of all devices on a network).

FIG. 2 depicts system 200 in accordance with embodiments of the present disclosure. In one embodiment, enterprise mobile devices 206 and/or enterprise network devices 204 are exposed to network 202. Network 202 may be the Internet, private network (e.g., Intranet), or other source of data (e.g., USB drive, magnetic media, optical media, etc.). Sentinel 208, utilizing sentinel DNA database 210 with malware signatures, provides a first defense from malware, such as to block, remove, deactivate, etc., known malware signatures. Unknown data may be evaluated on a computing platform, such as an ANNI High-Performance HPC 212 (or as used herein, “HPC” 212) and, if necessary, allow the suspect data to operate in the virtual sandbox 214.

PASS utilizes HPC 212 that may be purpose built to accomplish systems and network security. Security is provided quickly, up to and including near real time, as may be determined by implementation configuration. It should be appreciated that “near real time,” as generally understood by one of ordinary skill in the art, and as used herein, to refer to an action that would incur instantly (real time), if it were not for the unavoidable and inherent delay caused by the physical properties of the computing and networking components and systems utilized (e.g., the speed of an electrical signal through a processor, the speed of light through an optical data cable, the speed of radio waves to and from a wireless device, etc.). In another embodiment, near real time may refer to an initiation of a particular security operation.

Data is transmitted over the network and inspected by our Sentinel Sensor Array (“Sentinel”) 208 and held in a virtual machine (VM) until it is determined to be non-malicious. Data is then run through one or more filters to automatically determine whether it contains known malware or undetermined (e.g., cannot conclude the data is entirely absent malware) by comparison to known malware and malware variants, or by inclusion of a uniform resource locator (URL) known to distribute malware, via comparison to entries stored in a database, such as a Centralized Threat Information Database (CTID), which may be, be comprise by, or comprise sentinel DNA database 210. Additionally, or alternatively, a database of known malware variants located at the PASS Sentinel may be utilized, such as to facilitate expediency. The CTID may be updated, through the use of collectors, from other PASS systems.

Data, such as a file or code segment, does not have to be proven with 100% certainty to be malware as it may only contain an element of malicious code, whereby PASS then utilizes a decision tree to determine whether the element is or is not malicious. For example, if PASS determines the data or element is 30% unknown, the fully autonomous behavioral analysis instruction set (such as executing on one or more of Sentinel 208 or HPC 212) code may then make the further determination whether to send the captured data to a separate PASS proprietary de-engineering sandbox 214, for behavioral analysis. Once the behavior (e.g., context of the data elements) of the data is determined, then a hash or variant may be automatically forwarded to a front-end anti-virus system, such as to implement a (scan) search and destroy operation. As a benefit of the systems and methods disclosed herein, the time required to detect malware and implement a response very short, often under a second and commonly under one-half second. As each of these malware variants are captured and collected, the system becomes increasingly more effective by incorporating collected variants within the CTID database which may then be distributed to Sentinel 208 and/or ANNI EndPoint (AEP). AEP receives the updates without the need to perform capture and analyze operations itself.

The AI may then determine whether to forward the malicious signature to the AEP front end which resides on enterprise devices 204, which may include, but is not limited to, servers, PCs, laptops, etc. for which protection is sought. In another embodiment, AEP front end may reside on enterprise mobile devices 206.

In another embodiment, a system is disclosed comprising:

Centralized Threat Information Database “CTID” which may be centrally located and/or located at a single physical location;

Sentinel: An embodiment of the centralized intelligence of the PASS system which analyzes packet data and houses one or more malware databases (See FIG. 2, Sentinel 208 and Sentinel DNA database 210);

Sensor Array: Network packet collector which captures data transmitted over the network at the gateways or in line within a network segment;

Behavioral Analysis Engine: A “sandbox” to determine context of the data transmitted for malicious activity without exposing potential malware to end point devices (See FIG. 2, virtual sandbox 214);

Roamer: searches for malware and/or malware variants;

A user interface, such as a web interface for interactions between a human user and the system;

Predator: Providing countermeasure to destroy malware (e.g., remove, deactivate, etc.) upon receiving a request from PASS to the ANNI EndPoint wrapper whereby the database maintains bi-directional communication and may then inject newly discovered malware signatures for a single discrete malware scan or saved for a full malware scan by the AV product; and

Real time databases: which may further semantic and/or fully autonomous/behavioral analysis (context results) Instruction Set as a Dynamic Near Real Time In RAM database. In a further embodiment, the real time databases comprise six databases, two of which are semantic and four of which are autonomous/behavioral analysis (context results) Instruction Set as a Dynamic Real Time In RAM database. It should be appreciated that in other embodiments, databases may be combined and/or separated into different counts of different database types.

In another embodiment, specificity of a particular piece of data/code is used to determine if it has a high likelihood of being malware or not through the implementation of fully autonomous coding techniques. For example, a particular snippet of code is determined to be, or likely to be, malware. In contrast to other techniques, such as the use of a plurality of data being introduced into a semantic search engine.

In another embodiment, a decision tree is constructed to enable fully autonomous decision making.

ANNI EndPoint Predator/ANNI EndPoint Wrapper:

In one embodiment, a database is replaced by “Fully Autonomous/Behavioral Analysis (results) Instruction Set as a Dynamic Real Time In RAM database” in some applications

PASS maintains a CTID, which may be centralized, and comprise a plurality of feeds that provide input on malware, and other malicious code and URLs. The CTID may then be placed in a front end of the system. Accordingly, a first check against new transmitted code/packets whether coming into the system or leaving is provided and, in another embodiment, is provided by an in-RAM database. PASS may also take the database and add entries to it as new forms or variants of malware are discovered. Then, additional clients may be updated thereafter.

As a new form of malware or variants are discovered, PASS maintains the ability to communicate to ANNI EndPoint Predators, such as comprising anti-virus code and residing on user endpoints, such as laptops, computers, servers, etc. The ANNI EndPoint Applet may then be given a command to locate and destroy a newly discovered malware through the use of a hash/identifier signature. AEP Predator may then be utilized for a singular search/destroy command, without having to run a full scan, to identify the particular piece of malware, often within a second timeframe. ANNI EndPoint performs such functions (e.g., the search/destroy operations of AEP Predator). As a benefit of utilization of system “slow times”, protection may be provided without utilization of systems resources that would slow down a user's experience on a target device being protected. In a further embodiment, the “slow times” may be periods of diminished activity and/or system interrupts. In another embodiment, the diminished activity may be specific to a particular computing resource. For example, AEP may perform communication-intensive operations when the system is otherwise engaged in operations that requires diminished amount of communication resources (e.g., idle, processor-intensive operations, etc.) and vice versa.

ANNI EndPoint may also run within a wrapper enveloping an existing anti-virus software package. Newly found malware signatures may be injected into the existing anti-virus code, as a benefit real time protection may be provided to files that are downloaded by the user. Prior art typical performs detection, de-engineering and hash identification over a period of several months, commonly three to six months. With benefit of the teachings herein, PASS, using ANNI EndPoint Wrapper and Predator requires less than a few minutes, often less than two or even one depending on implementation, to accomplish similar results as well as to identify, locate, and destroy the malware. Additionally, ANNI EndPoint Wrapper is provided to operate bi-directionally with the anti-virus database to inject all newly PASS create malware signatures into the anti-virus database which may be moved up on a security architecture for system expediency and effectiveness.

Roamer may then work in conjunction with ANNI EndPoint Predator to locate the malware. Predator (or ANNI Endpoint Predator) provides the search and destroy function of ANNI EndPoint.

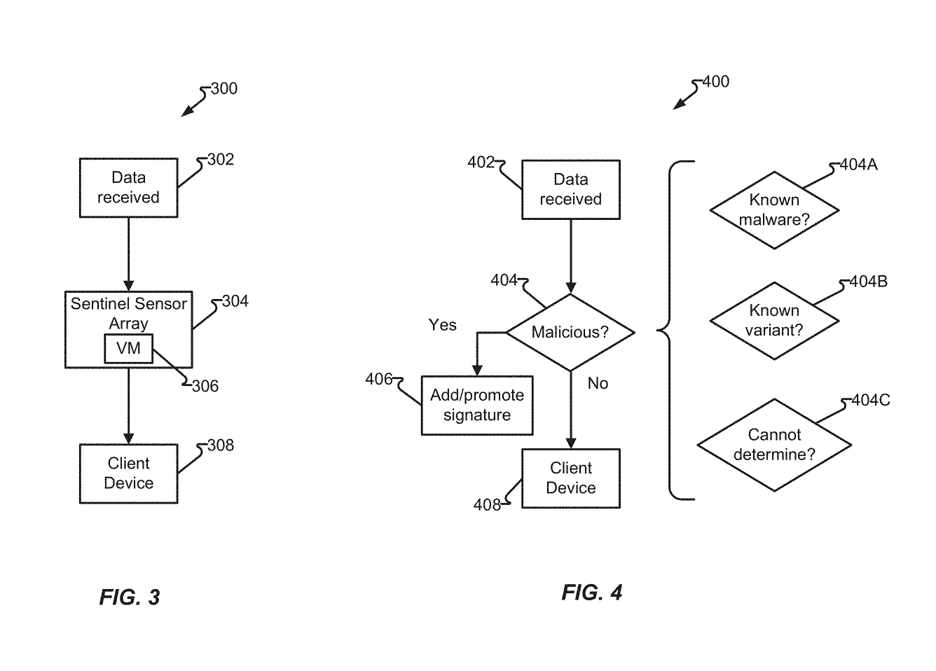

FIG. 3 depicts process 300 in accordance with embodiments of the present disclosure. In one embodiment, data is received in step 302, such as from network 202. Sentinel sensor array 304 may comprise virtual machine 306 and may execute during system slow times, and may be performed by Sentinel 208. Data determined, to be non-malware is provided to client device 308, for example one of enterprise mobile devices 206 or enterprise network devices 204.

FIG. 4 depicts process 400 in accordance with embodiments of the present disclosure. In one embodiment, data is received in step 402, such as from network 202, and determined, at step 404, to be malicious or unknown, such as may be performed by Sentinel 208. If step 404 is determined in the negative, the data is provided to client device at step 408, for example one of enterprise mobile devices 206 or enterprise network devices 204. If step 404 is determined in the affirmative, process 400 may continue to step 406 whereby a newly discovered signature is added to a database, such as CTID and/or sentinel DNA database 210. If already known, the corresponding malware signature may be promoted such as to facilitate improved detection speed upon a subsequent encounter.

In another embodiment, step 404 may comprise one or more other evaluation criteria, such as step 404A, whereby the data received is determined to or not to comprise known malware, step 404B, whereby the data received is determined to or not to comprise a known malware variant, and/or step 404C, whereby the data received is determined to or not to be malware based on an inability to conclusively determine whether the data is malware free.

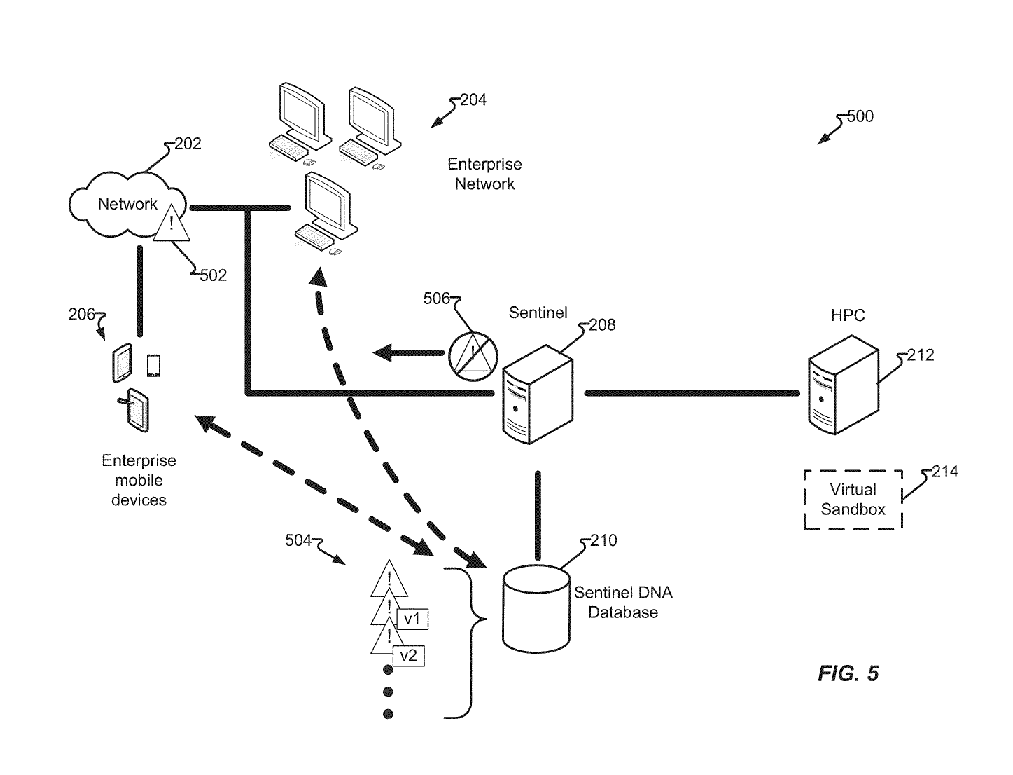

FIG. 5 depicts system 500 in accordance with embodiments of the present disclosure. In one embodiment, system 500 discloses components and operations to respond to threat 502, which is known to at least one component of system 500. Threat 502 is detected by Sentinel 208, enterprise mobile devices 206, enterprise network devices 204 and/or HPC 212. In one particular embodiment, threat 502 is detected by Sentinel 208 performing a deep inspection of packets, such as those originating from network 202. Sentinel 208 may utilize a data repository, such as an internal memory, storage device, sentinel DNA database 210, etc. as a source of malware signatures. Upon Sentinel 208 determining that threat 502 matches a known signature 504 comprising a signature of threat 502 and/or known variants of threat 502. Accordingly, server 506 may launch response 506 to prevent, disable, remove, block, isolate, inoculate, and/or other appropriate action for a device (e.g., one or more of enterprise mobile devices 206 and/or enterprise network devices 204) as may be provided by Sentinel 208 in accord with threat 502.

Response 506 may be specific to threat 502 or generic for all or a plurality of threats. Sentinel 208 may utilize a destination MAC address and/or IP address of threat 502 to identify compromised or potentially compromised devices.

Sentinel 208 may be embodied as a server in communication with enterprise mobile devices 206 and enterprise network devices 204, in other embodiments, Sentinel 208 may execute on one, a plurality, or each of enterprise mobile devices 206 and enterprise network devices 204. The determination and detection of malware may result in accessing a signature, such as one or more of signatures 504, to determine if known malware is present. In another embodiment, the determination is performed during system interrupts to allow a device to operate in a manner that does not impede user operations. Should a device detect malware, sentinel DNA database 210 may be updated and the updates propagated to other instances of sentinel DNA database 210, such as instances local to each of enterprise mobile devices 206 and enterprise network devices 204. Additionally, sentinel DNA database 210 may comprise a gateway or other network edge device (not shown) to readily block known malware and/or known source of malware.

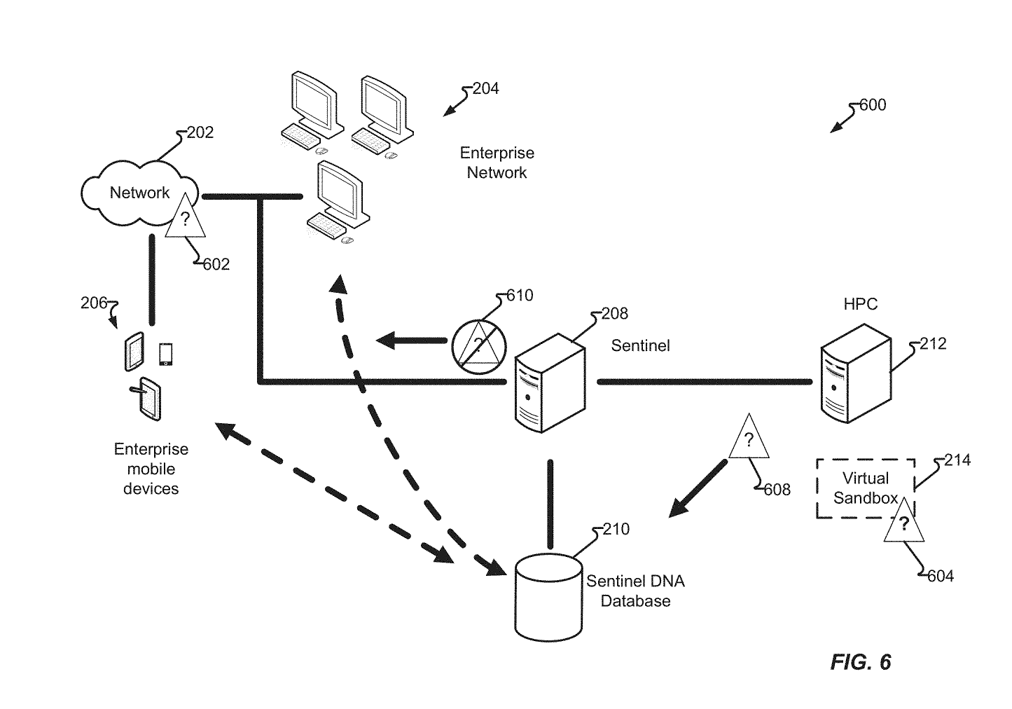

FIG. 6 depicts system 600 in accordance with embodiments of the present disclosure. In one embodiment, system 600 discloses components and operations to respond to threat 602, which is initially unknown to system 600. Sentinel 208 may monitor and deep inspect packets addressed to any one or more of devices, such as enterprise mobile devices 206 and/or enterprise network devices 204. Upon detecting a known or suspicious activity, source, operation, destination, and/or behavior, Sentinel 208 may take one or more actions. For example, a particular device (e.g., one or more of enterprise devices 204) may be isolated or shut down. In another example, Sentinel 208 may forward threat 602, or a signature thereof, to HPC 212. HPC 212 may place threat 604, which may be equivalent to threat 602 or a portion thereof, into sandbox 214 of HPC 212. Optionally, a sampling, most, or even every packet, such as every packet from network 202 destined to a device (e.g., one or more of enterprise mobile devices 206 and/or enterprise network devices 204) is placed into sandbox 214 and analyzed by HPC 212 for potential threats. As a result, threat 602 may initially be all packet until determined to be benign.

In another embodiment, HPC 212 may simulate system 600, with respect to what is, or is reasonably likely, to be components of system 600. For example, a particular one or more of enterprise mobile devices 206 and/or enterprise network devices 204, or a component thereof, may be modeled in sandbox 214 and threat 604 enabled to operate within sandbox 214 as it would with an actual device or component. HPC 212 observes the actions of threat 604 and, if determined to be a non-threat, allowed to continue interacting with its intended destination device. Optionally, threat 604 may be added to a “whitelist,” such as on sentinel DNA database 210 or a record therein. Should Sentinel 208 detect a future instance of threat 602, Sentinel 208 may be able to quickly determine, via accessing the whitelist, that no threat is present and, as a result, no burden systems and resource with unnecessary subsequent analysis of a known non-threat.

However, if HPC 212 determines that threat 604 is operating in sandbox 214 in a harmful manner or, optionally, operating in an unknown or unconventional manner, HPC 212 may determine threat 604 is malware. HPC 212 may cause sentinel DNA database 210 to be updated to comprise threat signature 608 sufficiently identifying threat 604 such that Sentinel 208 may identify and/or respond to threat 602. Sentinel 208 then initiate response 610 in response to threat 602, such as by blocking delivery of packets comprising threat 602 and/or other actions including, but not limited to, inoculating, removing, and/or disabling threat 602. Sentinel 208 may also update a firewall to block threat 602 and/or a source or destination associated with threat 602 and/or signature 608.

Should one or more devices (e.g., enterprise network devices 204) be determined to be, or may be, compromised, the particular device may be isolated by Sentinel 208 so as to contain threat 602 (e.g., shutting down, disabling a network connection, etc.) to a compromised device to limit, and preferably prevent, threat 602 from infecting or accessing other devices or components. In another embodiment, signature 608 may be forwarded to other components to enable improved detection of a future encounter of threat 602. In yet another embodiment, sentinel DNA database 210 comprises an antivirus database and signature 608 may then comprise a virus signature.

While Sentinel 208 may be embodied as a server in communication with enterprise mobile devices 206 and enterprise network devices 204, in other embodiments, Sentinel 208 may execute on one, a plurality, or each of enterprise mobile devices 206 and enterprise network devices 204. The detection of malware may result in a signature, such as signature 608, to be updated to one instance of sentinel DNA database 210 which, then updates other instances of sentinel DNA database 210 on a period and/or event basis. In another embodiment, when Sentinel 208 is embodied on at least one of enterprise mobile devices 206 or enterprise network devices 204, one or more of the detection, determination, and/or response (e.g., response 610) is performed during system interrupts to allow a device to operate in a manner that does not impede user operations. Additionally, sentinel DNA database 210 may comprise a gateway or other network edge device (not shown) and be updated with threat signature 608 to facilitate the gateway blocking a now-known malware and/or now-known source malware.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU), or logic circuits programmed with the instructions to perform the methods (FPGA). These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium, such as a storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
receiving, by a first server connected to a network, a first data addressed to a device;
determining, that the first data comprises a malware signature; and
in response to the determination, causing an agent to execute on the device to perform at least one of finding or destroying a second data comprising the malware signature, wherein the agent executes during a slow time of a processor of the device.

2. The method of claim 1, wherein the slow time comprises a system interrupt.

3. The method of claim 1, wherein the slow time comprises a reduced activity on at least one portion of device utilized by the agent.

4. The method of claim 1, further comprising, providing an indicia of the malware signature, via the network, to a second server.

5. The method of claim 1, wherein the determination that the first data comprises a malware signature comprises a determination that the first data comprises an unknown operation.

6. The method of claim 5, further comprising:
accessing a virtual sandbox;
delivering the first data to the virtual sandbox;
executing the first data within the virtual sandbox;
monitoring the execution of the first data within the virtual sandbox; and
upon the monitoring of the execution concluding that the first data performs no harmful operation, allowing the first data to be delivered to the device and, otherwise, identifying the first data as malware.

7. The method of claim 6, wherein the virtual sandbox is configured to mimic the device.

8. The method of claim 6, wherein the malware signature comprises a plurality of malware signatures and, upon identifying the first data as malware, adding a signature of the first data to the plurality of malware signatures.

9. The method of claim 8, wherein the plurality of malware signatures is in hierarchy order of likelihood to be encountered and, upon determining the plurality of malware signature already comprises the signature of the first data, promoting the malware signature within the hierarchy.

10. A system, comprising:
a server, comprising a processor, a memory, and a network interface to a network; and
wherein the processor of the server:
receives a first data addressed to a device attached to the network;
determines that the first data comprises a malware signature; and
in response to the determination, executes an agent to perform at least one of finding or destroying a second data comprising the malware signature; and
wherein the agent executes during a slow time of the processor;

11. The system of claim 10, wherein the execution of the agent is performed by a processor of the device.

12. The system of claim 10, wherein the slow time comprises a system interrupt.

13. The system of claim 10, wherein the slow time comprises a reduced activity on at least one portion of device utilized by the agent.

14. The system of claim 10, further comprising, providing an indicia of the malware signature, via the network, to a second server.

15. The system of claim 10, wherein the determination that the first data comprises a malware signature comprises a determination that the first data comprises an unknown operation.

16. The system of claim 15, further comprising:
the processor:
accessing a virtual sandbox;
delivering the first data to the virtual sandbox;
executing the first data within the virtual sandbox;
monitoring the execution of the first data within the virtual sandbox; and
upon the monitoring of the execution concluding that the first data performs no harmful operation, allowing the first data to be delivered to the device and, otherwise, identifying the first data as malware.

17. A system comprising:
means for receiving a first data addressed to a device;
means for determining that the first data comprises a malware signature; and
in response to the determination, means for causing an agent to execute on the device to perform at least one of finding or destroying a second data comprising the malware signature, wherein the agent executes during a slow time of a processor of the device.

18. The system of claim 17, wherein the slow time comprises a system interrupt.

19. The system of claim 17, wherein the determination that the first data comprises a malware signature comprises a determination that the first data comprises an unknown operation.

20. The system of claim 17, further comprising, upon determining the first data comprises the malware signature performing one of adding a record comprising indicia of the malware signature to a database or promoting the record comprising indicia of the malware signature in a database where the record comprising the indicia of the malware signature is determined to already exist.
